(19) United States
(12) Patent Application Publication
(10) Pub. No.: US 2026/0217119 A1
(43) Pub. Date: Jul. 30, 2026

(54) MOBILE DEVICE, IMAGE GENERATION METHOD, AND NON-TRANSITORY COMPUTER-READABLE STORAGE MEDIUM

(71) Applicant: HONDA MOTOR CO., LTD., Tokyo (JP)

(72) Inventors: Tamito KAWATE, Tokyo (JP); Jin OKUMURA, Tokyo (JP); Hideto SHIOTANI, Tokyo (JP)

(73) Assignee: HONDA MOTOR CO., LTD., Tokyo (JP)

(21) Appl. No.: 19/453,501

(22) Filed: Jan. 20, 2026

(30) Foreign Application Priority Data
Jan. 24, 2025 (CN) 202510116788.0

(51) Int. Cl. B60K 35/28; B60K 35/22; B60K 35/29; G06T 11/00

(52) U.S. Cl. CPC B60K 35/28; B60K 35/22; B60K 35/29; G06T 11/00; B60K 2360/179; G06T 2210/36; G06T 2210/62

(57) ABSTRACT

A mobile device includes an external information acquisition device configured to acquire external information around the mobile device, an acquisition device configured to acquire traffic participant information from the external information, and a display device configured to generate and display an image representing a traffic condition around the mobile device based on the external information and the traffic participant information. The traffic participant information includes attribute information of each traffic participant. When generating the image, the display device integrates a plurality of the traffic participants belonging to the same attribute and having a specific position relationship into an integrated traffic participant, and draws the integrated traffic participant as a single object. When detecting that the plurality of traffic participants are present ahead, the mobile device visually presents the traffic participants in a simplified and integrated group form, thereby reducing unnecessary complex information drawing.

### CROSS-REFERENCE TO RELATED APPLICATIONS

This application is based on and claims priority under 35 USC 119 from Chinese Patent Application No. 202510116788.0 filed on Jan. 24, 2025, the entire content of which is incorporated herein by reference.

### TECHNICAL FIELD

The present disclosure relates to a mobile device, an image generation method, and a non-transitory computer-readable storage medium storing a computer program.

### BACKGROUND ART

In recent years, with the increasing attention of society to vulnerable traffic participants, providing accessibility to sustainable transportation systems has become one of the key directions of research and development. Especially in terms of improving traffic safety and convenience, rapid progress has been made in the research and development of driving assistance technologies.

With the development of the driving assistance technologies, an existing driving system can detect a traffic condition and an obstacle (for example, another vehicle, a pedestrian, a signal light, or a road cone) around a vehicle in real time, and draw related information of a peripheral environment and the obstacle by using a display screen, to visually present the related information to a user and to help the user understand a dynamic environment around the vehicle.

### SUMMARY OF INVENTION

However, drawing all the detected information one by one will cause excessive information to be displayed on the display screen, making it difficult for the user to quickly recognize which information is closely related to driving safety, resulting in information complexity. In addition, excessive drawing information will significantly increase the rendering load of the system, resulting in an increase in the computing pressure of a processor. Especially for electric vehicles, an excessive processing load and power consumption will directly affect a range, increase power consumption of an in-vehicle system, and reduce overall energy efficiency and comfort in the vehicle.

A technical problem to be solved by the present invention is to provide a mobile device, an image generation method, and a non-transitory computer-readable storage medium storing a computer program that can optimize visual information on a display screen, help a driver quickly understand important information related to a vehicle, improve driving safety, and effectively reduce a processing load and power consumption of a display system, thereby improving energy efficiency of an in-vehicle system, and improving overall in-vehicle comfort and user experience.

The present invention provides a mobile device including: an external information acquisition device configured to acquire external information around the mobile device; an acquisition device configured to acquire traffic participant information from the external information; and a display device configured to generate and display an image representing a traffic condition around the mobile device based on the external information and the traffic participant information, in which the traffic participant information includes attribute information of each traffic participant, and when generating the image, the display device integrates a plurality of the traffic participants belonging to a same attribute and having a specific position relationship into an integrated traffic participant, and draws the integrated traffic participant as a single object.

The present invention further provides a method for generating and displaying an image representing a traffic condition around a mobile device, the method including steps of: executed by a computer installed in the mobile device, acquiring traffic participant information from external information around the mobile device acquired by an external information acquisition device of the mobile device; and generating and displaying the image representing the traffic condition around the mobile device based on the external information and the traffic participant information, in which when the image is generated, a plurality of traffic participants belonging to a same attribute and having a specific position relationship are integrated into one integrated traffic participant, and the integrated traffic participant is drawn as one single object.

The present invention further provides a non-transitory computer-readable storage medium storing a computer program having instructions which cause a computer to execute the above method.

According to the mobile device, the image generation method and the non-transitory computer-readable storage medium storing the computer program of the present invention, when it is detected that the plurality of traffic participants are present in front, the traffic participants with a specific position relationship are recognized as a group, and visually presented on the display screen in a simplified and integrated group form, thereby reducing unnecessary complex information drawing, simplifying visual information on the display screen, helping the driver quickly understand important information related to the vehicle, effectively reducing the processing load and the power consumption of the display system, and prolonging a range of an electric vehicle. In this way, energy efficiency of the in-vehicle system is improved, and overall in-vehicle comfort and user experience are improved.

### BRIEF DESCRIPTION OF DRAWINGS

Exemplary embodiment(s) of the present invention will be described in detail based on the following figures, wherein:

FIG. 1 is a side view illustrating an example of a vehicle equipped with a control device according to an embodiment of the present invention;

FIG. 2 is a top view of the vehicle of FIG. 1;

FIG. 3 is a block diagram illustrating an internal structure of the vehicle illustrated in FIG. 1;

FIG. 4 illustrates an example of a traffic participant integration manner of Embodiment 1 of a display control unit;

FIG. 5 illustrates an example of a screen displayed on a vehicle display device of Embodiment 1;

FIG. 6 illustrates an example of a traffic participant integration manner of Embodiment 2 of the display control unit;

FIG. 7 illustrates an example of a screen displayed on a vehicle display device of Embodiment 2;

FIG. 8 illustrates an example of a traffic participant integration manner of Embodiment 3 of the display control unit;

FIG. 9 illustrates an example of a screen displayed on a vehicle display device of Embodiment 3;

FIG. 10 illustrates an example of a traffic participant integration manner of Embodiment 4 of the display control unit;

FIG. 11 illustrates an example of a screen displayed on a vehicle display device of Embodiment 4; and

FIG. 12 illustrates an example of a traffic participant integration manner of Embodiment 5 of the display control unit.

### DESCRIPTION OF EMBODIMENTS

Hereinafter, embodiments of the present invention will be described with reference to the accompanying drawings. The same structures in the drawings are denoted by the same reference numerals. In the following description, front and rear, left and right, and up and down are defined according to the perspective of a driver, and the front of a vehicle is marked as Fr, the rear is marked as Rr, a left side is marked as L, a right side is marked as R, an upper side is marked as U, and a lower side is marked as D.

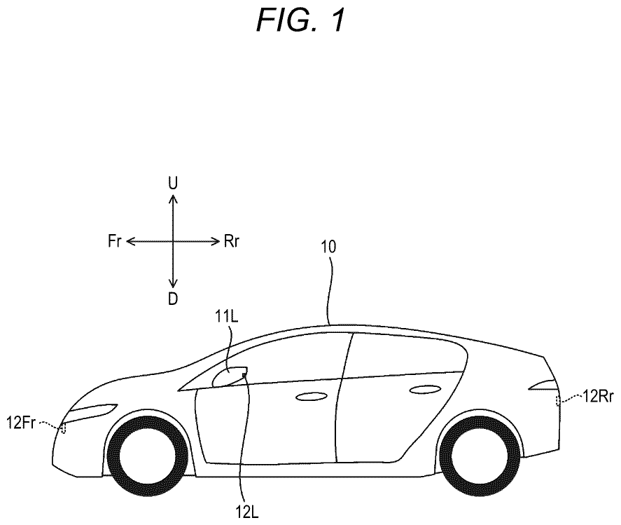

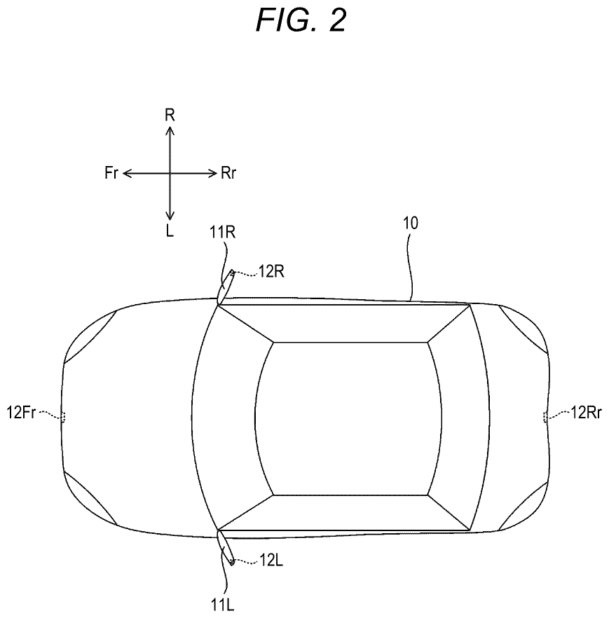

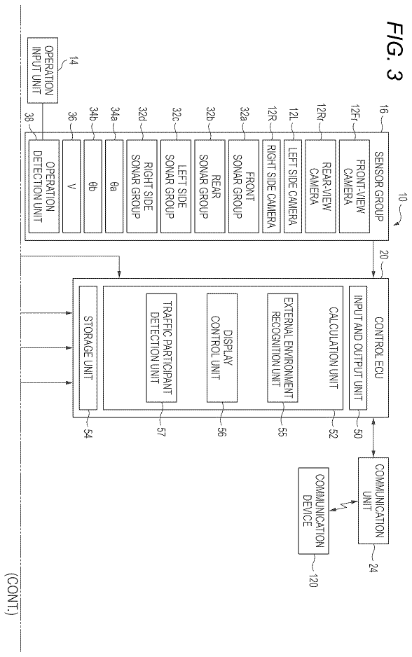

FIG. 1 is a side view illustrating a vehicle 10 of the present invention. FIG. 2 is a top view of the vehicle 10 illustrated in FIG. 1. The vehicle 10 is an example of a mobile device of the present invention.

The vehicle 10 is an automobile including a drive source (not illustrated), drive wheels driven by the power of the drive source, and steerable steered wheels. In the present embodiment, the vehicle 10 is a four-wheeled automobile with a pair of left and right front wheels and a pair of left and right rear wheels. The drive source of the vehicle 10 can be an electric motor. Further, the drive source of the vehicle 10 can also be an internal combustion engine such as a gasoline engine or a diesel engine, or a combination of the electric motor and the internal combustion engine. The drive source of the vehicle 10 can drive the pair of left and right front wheels, or can drive the pair of left and right rear wheels, or can simultaneously drive the four wheels, that is, the pair of left and right front wheels and rear wheels. The front wheels and the rear wheels can be steered wheels that are steerable simultaneously, or either the front wheels or the rear wheels can be steered wheels that are steerable.

The vehicle 10 is also equipped with a left side mirror 11L and a right side mirror 11R. The left side mirror 11L and the right side mirror 11R are rear-view mirrors mounted outside front doors of the vehicle 10 for the driver to confirm the rear and side rear conditions. The left side mirror 11L and the right side mirror 11R are respectively fixed on a vehicle body of the vehicle 10 through a vertical rotation shaft, and can rotate around the rotation shaft to achieve opening and closing.

The vehicle 10 is also equipped with a front-view camera 12Fr, a rear-view camera 12Rr, a left side camera 12L, and a right side camera 12R (hereinafter, sometimes collectively referred to as “cameras 12”). The front-view camera 12Fr is mounted in the front of the vehicle 10, for example, on an upper portion of a front windshield or a rear side of an interior rear-view mirror, and is configured to capture a front orientation of the vehicle 10. The rear-view camera 12Rr is mounted on a rear side of the vehicle 10, for example, mounted on an upper portion of a rear windshield or a rear door, and is configured to capture a rear orientation of the vehicle 10. The left side camera 12L is mounted at a position such as the left side mirror 11L of the vehicle 10, and is configured to image a left orientation of the vehicle 10.

The right side camera 12R is mounted at a position such as the right side mirror 11R of the vehicle 10, and is configured to image a right orientation of the vehicle 10. These cameras 12 are used to image a surrounding environment in the corresponding orientations of the vehicle 10 and generate images, and are, for example, digital cameras using solid-state image sensors such as a charge coupled device (CCD) or a complementary metal oxide semiconductor (CMOS). The cameras 12 can periodically and repeatedly image the 10 surrounding environment of the vehicle 10, or can be stereo cameras.

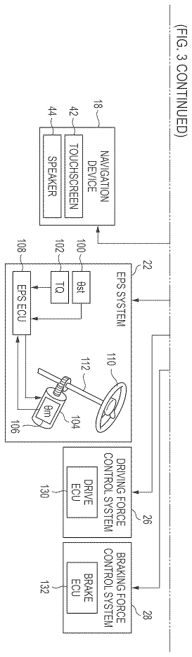

FIG. 3 is a block diagram of an example of an internal structure of the vehicle 10 illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28. The control ECU 20 is an example of a control device of the present invention.

The sensor group 16 is configured to acquire various detection values required for control by the control ECU 20. The sensor group 16 includes the front-view camera 12Fr, the rear-view camera 12Rr, the left side camera 12L, and the right side camera 12R. In addition, the sensor group 16 further includes a front sonar group 32a, a rear sonar group 32b, a left side sonar group 32c, and a right side sonar group 32d. The sensor group 16 further includes wheel sensors 34a, 34b, a vehicle speed sensor 36, and an operation detection unit 38.

The front-view camera 12Fr, the rear-view camera 12Rr, the left side camera 12L, and the right side camera 12R image the surrounding environment of the vehicle 10 to acquire recognition data (for example, peripheral images) for recognizing an environment outside the vehicle 10. The peripheral images imaged by the front-view camera 12Fr, the rear-view camera 12Rr, the left side camera 12L, and the right side camera 12R are referred to as a front image, a rear image, a left image, and a right image, respectively. An image formed by the left image and the right image can also be referred to as a side image. Imaging data of each of the front-view camera 12Fr, the rear-view camera 12Rr, the left side camera 12L and the right side camera 12R can generate an external environment recognition image.

The front sonar group 32a, the rear sonar group 32b, the left side sonar group 32c, and the right side sonar group 32d (hereinafter, also collectively referred to as “sonar groups 32”) emit sound waves around the vehicle 10 and receive echoes reflected from other objects. The front sonar group 32a includes, for example, four sonars, and components thereof are respectively disposed on a left front side, a front left side, a front right side, and a right front side of the vehicle 10. The rear sonar group 32b includes, for example, four sonars, and components thereof are respectively disposed on a left rear side, a rear left side, a rear right side, and a right rear side of the vehicle 10. The left side sonar group 32c includes, for example, two sonars, and components thereof are respectively disposed on the left front side and the left rear side of the vehicle 10. The right side sonar group 32d includes, for example, two sonars, and components thereof are respectively disposed on the right front side and the right rear side of the vehicle 10.

The wheel sensors 34a, 34b are used to detect rotation angles of the wheels of the vehicle 10. The wheel sensors 34a, 34b can be implemented by angle sensors or displacement sensors. The wheel sensors 34a, 34b output detection pulses each time the wheels rotate an angle. These detection pulses are used to calculate the rotation angles and rotation speeds of the wheels. A travel distance of the vehicle 10 can be calculated according to the rotation angles of the wheels. For example, the wheel sensor 34a detects a rotation angle da of a left rear wheel, and the wheel sensor 34b detects a rotation angle θb of a right rear wheel.

The vehicle speed sensor 36 is configured to detect a speed (that is, a vehicle speed V) of a vehicle body of the vehicle 10, and output the detected vehicle speed V to the control ECU 20. The vehicle speed sensor 36 detects the vehicle speed V, for example, based on rotation of a transmission reverse shaft.

The operation detection unit 38 detects operation content performed by a user through the operation input unit 14, and outputs the detected operation content to the control ECU 20. The operation input unit 14 includes various user interfaces, such as a rear-view mirror switch for switching open and closed states of the left side mirror 11L and the right side mirror 11R and a shift lever (selection lever or selector).

The navigation device 18 detects a current location of the vehicle 10, for example, via the Global Positioning System (GPS), and generates a path that guides the user to a destination. The navigation device 18 includes a storage device (not illustrated) that stores a map information database.

The navigation device 18 is equipped with a touchscreen 42 and a speaker 44. The touchscreen 42 operates as an input device and a display device of the control ECU 20. The speaker 44 outputs various guidance information in a voice form to the user of the vehicle 10.

The touchscreen 42 is configured to input various instructions to the control ECU 20. For example, the user can input instructions related to movement support of the vehicle 10 via the touchscreen 42. The movement support includes parking assistance and exit support for the vehicle 10. In addition, the touchscreen 42 may further display various interfaces related to control content of the control ECU 20. For example, the touchscreen 42 displays an interface related to the movement support of the vehicle 10, and specifically includes a parking support button for requesting automatic parking for the vehicle 10 and an exit support button for requesting exiting for the vehicle 10. The parking support button may be used to request the control ECU 20 to perform autonomous driving parking, and a parking assistance button may be used to request assistance when the driver is parking. The exit support button includes an automatic exit button for requesting the control ECU 20 to perform autonomous driving exit, and an exit assistance button for requesting assistance when the driver is exiting. In addition, devices other than touchscreens, such as smartphones or tablets, can also be used as input devices or display devices. The touchscreen 42 is configured to input various instructions to the control ECU 20. For example, the user can input an instruction for displaying the external environment recognition image of the vehicle 10 through the touchscreen 42. In addition, the touchscreen 42 is further configured to display various screens related to the control content of the control ECU 20. For example, the external environment recognition image of the vehicle 10 can be displayed on the touchscreen 42. It should be noted that in addition to the touchscreen 42, other components (for example, a head-up display (HUD), a smartphone, and a tablet) can be used as input devices or display devices.

The control ECU 20 includes an input and output unit 50, a calculation unit 52, and a storage unit 54. The calculation unit 52 is implemented by a central processing unit (CPU). The calculation unit 52 controls components to perform various control operations according to the program stored in the storage unit 54. Further, the calculation unit 52 performs signal input and output with the components connected to the control ECU 20 through the input and output unit 50. The calculation unit 52 includes an external environment recognition unit 55, a display control unit 56, and a traffic participant detection unit 57. The external environment recognition unit 55 is configured to recognize the external environment recognition image, the display control unit 56 performs display control on the external environment recognition image, and the traffic participant detection unit 57 recognizes traffic participants around the vehicle 10. Detailed structures of the external environment recognition unit 55, the display control unit 56 and the traffic participant detection unit 57 will be described later.

The EPS system 22 includes a rudder angle sensor 100, a torque sensor 102, an EPS motor 104, a rotary encoder 106, and an EPS ECU 108. The rudder angle sensor 100 detects a rudder angle θst of a steering device 110. The torque sensor 102 detects torque TQ exerted on the steering device 110.

By applying a driving force or a reaction force to the steering device 110 connected to a steering column 112, the EPS motor 104 implements steering operation support for an occupant and automatic steering during parking support. The rotary encoder 106 detects a rotation angle θm of the EPS motor 104. The EPS ECU 108 is responsible for overall control of the EPS system 22. The EPS ECU 108 is equipped with an input and output unit (not illustrated), a calculation unit (not illustrated), and a storage unit (not illustrated).

The communication unit 24 is capable of performing wireless communication with other communication devices 120. The other communication devices 120 include a base station, a communication device of another vehicle, a smartphone or a tablet carried by the user of the vehicle 10, or the like. The communication unit 24 is an example of the communication unit of the present invention. A smartphone and a tablet are examples of an information terminal of the present invention.

The driving force control system 26 is equipped with a drive ECU 130. The driving force control system 26 controls a driving force of the vehicle 10. The drive ECU 130 controls the driving force of the vehicle 10 based on user operation of an accelerator pedal (not illustrated), by controlling an engine (not illustrated) and the like.

The braking force control system 28 is equipped with a brake ECU 132. The braking force control system 28 controls a braking force of the vehicle 10. The brake ECU 132 controls the braking force of the vehicle 10 based on user operation of a brake pedal (not illustrated), by controlling a braking mechanism (not illustrated) and the like.

### <External Environment Recognition Unit>

The external environment recognition unit 55 is responsible for acquiring image data from the plurality of cameras and recognizing environmental information around the vehicle 10, extracting useful article information by processing and analyzing the image data, and generating an external environment recognition image A. Specifically, the external environment recognition unit 55 acquires environment images around the vehicle 10 through the front-view camera 12Fr, the rear-view camera 12Rr, the left side camera 12L, and the right side camera 12R. Then, the external environment recognition unit 55 processes the acquired image by using a computer vision algorithm (for example, a deep learning model or a traditional image processing method), analyzes an object in the image, recognizes a road, a traffic sign, an obstacle (such as a parked vehicle or a roadblock), a pedestrian, an animal, and the like, and generates the external environment recognition image A.

The external environment recognition unit 55 further performs scene understanding on the acquired environment images by combining the map with the positioning information, and combines information of a plurality of objects to perform higher-level analysis on the environment images. For example, the external environment recognition unit 55 can determine a lane position and a traveling direction according to a current position and a real-time traffic condition, recognize infrastructure such as a road ahead, a traffic sign, a curb, and a lane line from the environment images, and other vehicles during driving, and accurately calculate a position, a size, and a shape of a surrounding object, so as to establish a three-dimensional model of a surrounding environment of the vehicle and model a road geometry. In an autonomous driving mode, the external environment recognition unit 55 can update the external environment recognition image A around the vehicle in real time to provide accurate basic data for path planning.

In addition to relying on the cameras alone, the external environment recognition unit 55 may also fuse data from other sensors. For example, a capability of sensing the surrounding environment can be enhanced by combining data from sensors such as LiDAR, radar, and sonar. Through the sensor fusion, the external environment recognition unit 55 can acquire more accurate obstacle detection and position estimation, especially under conditions such as low light and severe weather, and the sensor fusion can effectively compensate for the deficiency of a single sensor and improve the robustness and accuracy of the system.

### <Traffic Participant Detection Unit>

The traffic participant detection unit 57 further extracts information on a traffic-related participant M from the external environment recognition image A. The traffic participant M includes all objects participating in traffic together with the vehicle 10, such as pedestrians, other vehicles, bicycles, non-motor vehicles, and animals. The traffic participant detection unit 57 not only performs basic recognition on the traffic participants M, but also assigns multi-dimensional attribute information to each recognized traffic participant M to construct a traffic participant information table. Table 1 illustrates an example of the traffic participant information table.

TABLE 1
Traffic Participant Information Table

| Field name | Description |
|---|---|
| ID | Unique identifier for identifying each traffic participant |
| Type | Type of traffic participant (pedestrian, vehicle, bicycle, |
| | animal, etc.) |
| Distance | Distance from vehicle 10 (unit: meters) |
| Direction | Direction of traffic participant relative to vehicle |
| | (unit: degrees, 0 to 360) |
| Motion trend | Approaching, departing, moving in parallel, etc. |
| Speed | Speed of traffic participant (unit: m/s) |
| Priority | Priority value (high, medium, and low) |
| Area | Area (front, rear, left, and right) around vehicle where |
| | traffic participant is located |

### Field Description in Table 1

ID: a unique identifier of each traffic participant M, which facilitates tracking and updating.

Type: a type of the traffic participant M such as a pedestrian, a vehicle, a bicycle, or an animal is identified according to a result of an object detection model.

Distance: a linear distance between the traffic participant and the vehicle, with meters as the unit.

Direction: an azimuth angle of the traffic participant relative to the vehicle is described based on a vehicle coordinate system (for example, 0° is directly in front, 90° is on a right side, and 180° is directly behind).

Motion trend: a motion trend of the traffic participant relative to the vehicle is described based on the vehicle coordinate system, for example, approaching, departing, or moving in parallel.

Speed: a real-time speed of the traffic participant.

Priority: different priorities are assigned to the traffic participants M according to a predetermined rule. For example, a pedestrian pushing a stroller is given high priority.

Area: divided into front, rear, left, right areas and the like for quick positioning.

These pieces of attribute information are generated by analyzing image features, motion states, and sensor data.

Through image recognition technology generation based on machine learning, the traffic participants M are classified into specific categories, such as pedestrians, bicyclists, motorcycles, automobiles, large vehicles (such as trucks and buses), and animals.

After being recognized as a specific category, a secondary attribute can be further extracted. For example, whether the pedestrian is an adult or a child, and whether the vehicle is an emergency vehicle (for example, an ambulance).

The direction and the distance of the traffic participant M can be determined based on spatial positioning of sonar or LiDAR. For example, the distance and a position of the traffic participant M are calculated from echo data by using ultrasonic signals transmitted and received by the sonar group 32.

The motion trend and the speed of the traffic participant M can be determined based on the spatial positioning and a movement trend of the sonar. For example, the distance and the position of the traffic participant M are calculated from the echo data by using the ultrasonic signals transmitted and received by the sonar group 32, and a moving track and a moving speed of the traffic participant M are determined in combination with a sonar detection result in continuous time. In addition, data fusion can be performed by using a weighting algorithm or a deep learning model by combining visual information of the cameras 12 and the distance and orientation information provided by the sonar, and recognition accuracy is improved. Another method is to track the movement trend of the traffic participant M within a period of time by combining target tracking and historical data using an inter-frame difference or a target tracking algorithm (such as an optical flow method or a Kalman filter), and analyze whether the traffic participant M has continuous mobility and moving direction by comparing a recognition result at the current moment with historical data, thereby reducing false recognition.

### Display Control Unit: Embodiment 1

The display control unit 56 displays the external environment recognition image A acquired by the external environment recognition unit 55 on the display device (for example, the touchscreen 42) of the vehicle 10. Meanwhile, the display control unit 56 superimposes an image of the traffic participant M on the external environment recognition image A. If the plurality of traffic participants M belong to the same attribute and have a specific position relationship, these traffic participants are integrated into one traffic participant image for display. The specific position relationship, specifically, in Embodiment 1, means that the traffic participants are close to each other, that is, if the plurality of traffic participants M belong to the same attribute and are close to each other, the display control unit 56 integrates these traffic participants into one integrated traffic participant for display.

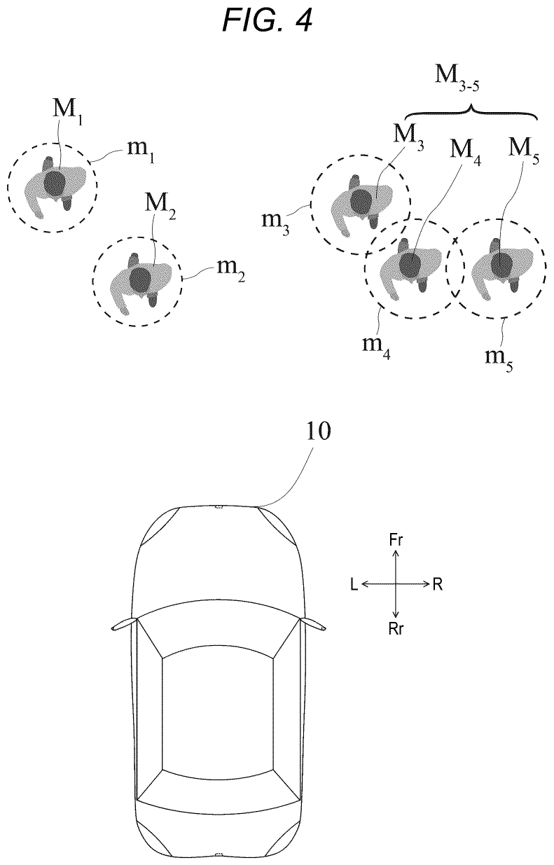

FIG. 4 illustrates an example of a traffic participant integration manner of Embodiment 1, and as illustrated in FIG. 4, the display control unit 56 first establishes a coordinate system on a top view plane of the vehicle 10 with the vehicle 10 as an origin, projects each traffic participant M into the coordinate system, and calculates the position of each traffic participant M in the vehicle coordinate system. Then, the display control unit 56 sets, for each traffic participant M, a circle m with the coordinates of the traffic participant as the center of the circle and a predetermined length as a radius, and determines whether there is an overlapping relationship between circles. FIG. 4 illustrates an example where the traffic participant M is a pedestrian, and a radius length may be set to a value slightly greater than a shoulder width of an adult.

If the circle m of the traffic participant M partially overlaps the circle m of another traffic participant M, these overlapping traffic participants are integrated into a single object, which is referred to as the “integrated traffic participant”. Whether the circles m overlap may be determined by calculating a relationship between a distance between two centers of the circles and a sum of the radii thereof. In the example illustrated in FIG. 4, for example, distances between a circle m₁ of a traffic participant M₁ and a circle m of any other traffic participant M, and between a circle m₂ of a traffic participant M₂ and the circle m of any other traffic participant M are both greater than a sum of the radii thereof, so that it is determined that the circles m₁, m₂ do not overlap the circle m of the other traffic participant M, and the traffic participants M₁, M₂ remain as individual traffic participants and are not integrated. Distances between the center of a circle m₄ of a traffic participant M₄ and the center of a circle m₃ of a traffic participant M₃, and between the center of a circle m₄ of a traffic participant M₄ and the center of a circle m₅ of a traffic participant M₅ are both less than or equal to a sum of the radii thereof, so that it is determined that the circle m₄ overlaps circles m₃ and m₅, and the traffic participants M₃ to M₅ are integrated into one integrated traffic participant M₃₋₅.

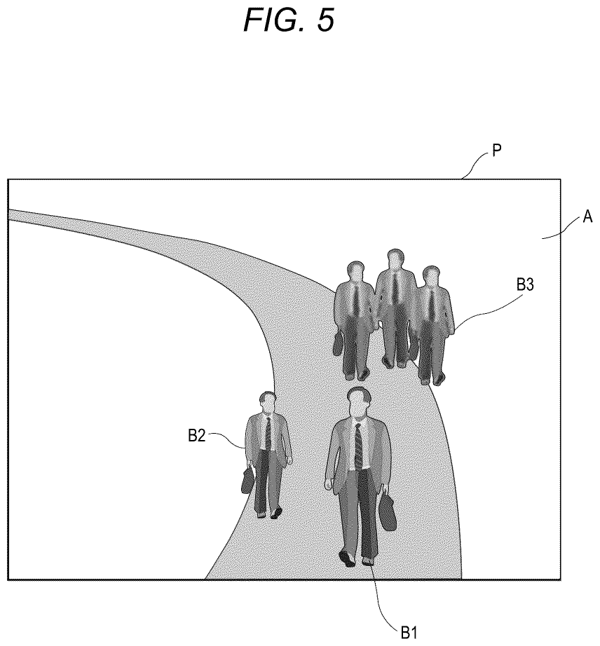

FIG. 5 illustrates an example of a screen displayed on a vehicle display device of Embodiment 1. As illustrated in FIG. 5, the display control unit 56 displays the external environment recognition image A generated by the external environment recognition unit 55 as a background on a screen P. Meanwhile, the display control unit 56 separately renders the individual traffic participants and the integrated traffic participant, and superimposes them on the external environment recognition image A according to the information on the traffic participants. Specifically, the individual traffic participants M₁, M₂ are drawn as traffic participant images B1, B2, respectively, and integrated traffic participant M₃₋₅ is drawn as a traffic participant image B3.

In the present embodiment, a plurality of traffic participants are recognized and integrated into one group, and visual presentation is performed on a display screen in a simplified and integrated group form, so that unnecessary complex information drawing can be significantly reduced. This method can simplify information display on the display screen and help the driver more quickly understand important information related to the vehicle. In addition, the integrated display can also effectively reduce a processing load and power consumption of a display system, thereby extending a range of the electric vehicle.

### Display Control Unit: Embodiment 2

In the present embodiment, the display control unit 56 further dynamically adjusts and integrates a level of drawing detail of the integrated traffic participants according to the distance between the integrated traffic participant and the vehicle 10, and divides the drawing into a plurality of levels.

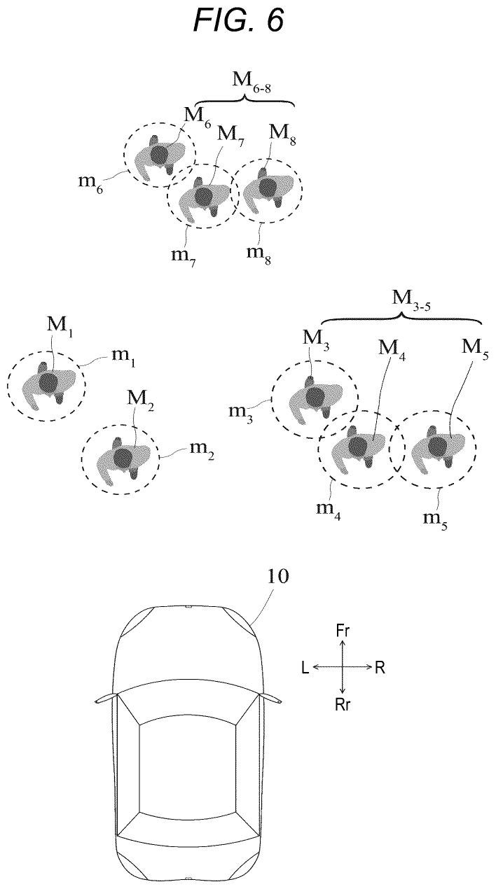

FIG. 6 illustrates an example of the traffic participant integration manner according to Embodiment 2, as illustrated in FIG. 6, the display control unit 56 determines that the traffic participants M₁, M₂ are individual traffic participants and does not integrate them, determines that the circle m₄ of the traffic participant M₄ overlaps the circle m₃ of the traffic participant M₃ and the circle m₅ of the traffic participant M₅, a circle m₇ of a traffic participant M₇ overlaps the circle me of the traffic participant M₆ and the circle m₅ of the traffic participant M₈, integrates the traffic participants M₃ to M₅ into one integrated traffic participant M₃₋₅, and integrates the traffic participants M₆ to M₅ into one integrated traffic participant M₆₋₈. An overlap determination manner is the same as that in Embodiment 1, and will not be repeated here.

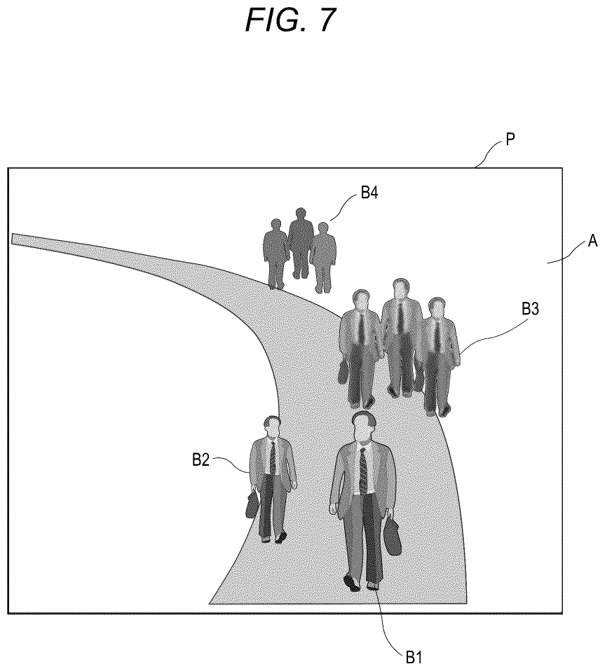

FIG. 7 illustrates an example of a screen displayed on a vehicle display device of Embodiment 2. As illustrated in FIG. 7, the display control unit 56 separately renders the individual traffic participants and the integrated traffic participant, and superimposes them on the external environment recognition image A according to the information on the traffic participants. Specifically, the individual traffic participants M₁, M₂ are drawn as the traffic participant images B1, B2, respectively, and integrated traffic participants M₃₋₅, M₆₋₈ are drawn as traffic participant images B3, B4, respectively. At this time, the display control unit 56 dynamically adjusts the level of drawing detail of the integrated traffic participant image according to the distance between the integrated traffic participant and the vehicle 10, and for example, divides the drawing into multiple levels as follows.

High level of detail (for example, distance within 20 meters): for an integrated traffic participant who is close to a vehicle, including more detail in drawing. For example, as illustrated in FIG. 7, the integrated traffic participant M₃₋₅ is close to the vehicle 10, and the rendered traffic participant image B3 draws an outline reflecting the number of traffic participants contained therein, and draws some facial details.

Medium level of detail (for example, distance between 20 to 100 meters): for an integrated traffic participant at a medium distance, for example, the integrated traffic participant M₆₋₈ who is far away from the vehicle 10. As illustrated in FIG. 7, the rendered traffic participant image B4 only draws an outline reflecting the number of traffic participants contained therein, and details are omitted.

Low level of detail (for example, distance beyond 100 meters): for an integrated traffic participant at a greater distance, simplified icons or outlines can be drawn, and details are further reduced.

Further, as the vehicle 10 moves, the distance between the integrated traffic participant and the vehicle changes in real time, and as the vehicle 10 approaches the integrated traffic participant, the display control unit 56 can gradually increase the level of drawing detail of the image. For example, when the integrated traffic participant M₆-8 enters a short-distance area from a medium-distance area, the image B4 is switched from the medium level of detail to the high level of detail, and the display control unit 56 can dynamically adjust the level of drawing detail according to the latest distance.

In this way, by dynamically adjusting the level of drawing detail, the display control unit 56 can optimize a display effect according to the distance between the integrated traffic participant and the vehicle, the short-distance object is drawn in more detail, the long-distance object is displayed in a simplified manner, an unnecessary rendering burden can be reduced, and at the same time, screen information is more intuitive and clear through the hierarchical display, and the information overload is avoided, so as to highlight an important object while saving the display resources.

### Display Control Unit: Embodiment 3

In the present embodiment, the display control unit 56 further adjusts a drawing manner of the traffic participant according to the motion trend of the traffic participant.

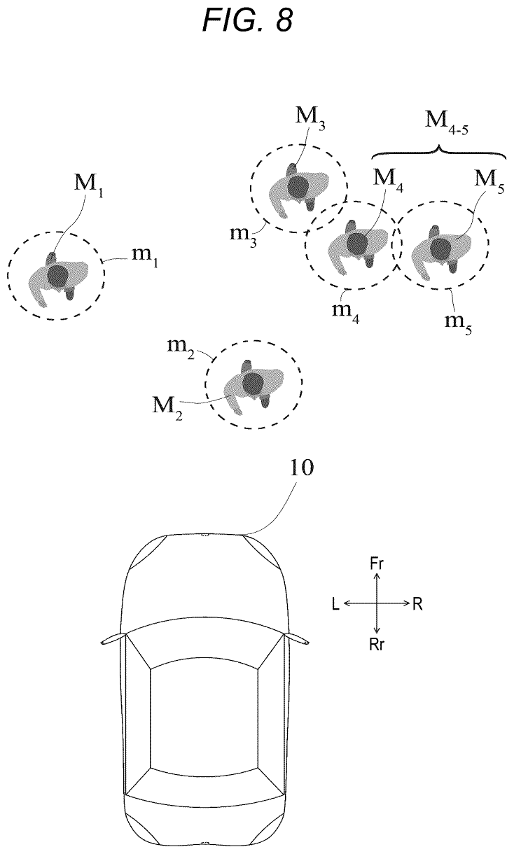

FIG. 8 illustrates an example of the traffic participant integration manner according to Embodiment 3, as illustrated in FIG. 8, the display control unit 56 determines that the traffic participants M₁, M₂ are individual traffic participants and does not integrate them, and determines that the circle m₄ of the traffic participant M₄ overlaps the circle m₃ of the traffic participant M₃ and the circle m₅ of the traffic participant M₅, and integrates the traffic participants M₃ to M₅ into one integrated traffic participant M₃₋₅. An overlap determination manner is the same as that in Embodiment 1, and will not be repeated here.

The display control unit 56 further detects whether a traffic participant whose moving direction is directed to the vehicle 10 (hereinafter, referred to as an “approaching traffic participant”) is present, and if the approaching traffic participant is present and is included in the integrated traffic participant, the display control unit 56 separates the approaching traffic participant from the integrated traffic participant.

Specifically, the display control unit 56 filters the motion trends of the traffic participants according to the field content of the traffic participant information table, and detects the traffic participants whose motion trends are “approaching”. As an example, in the present embodiment, only the motion trend of the traffic participant M₃ is “approaching”, so that the traffic participant M₃ is recognized as the approaching traffic participant. Since the approaching traffic participant M₃ is included in the integrated traffic participant M₃₋₅, the display control unit 56 separates M₃ from the integrated traffic participant as an individual traffic participant. The separated integrated traffic participant M₃₋₅ will only include M₄, M₅, and M₄, M₅ are reintegrated into an integrated traffic participant M₄₋₅.

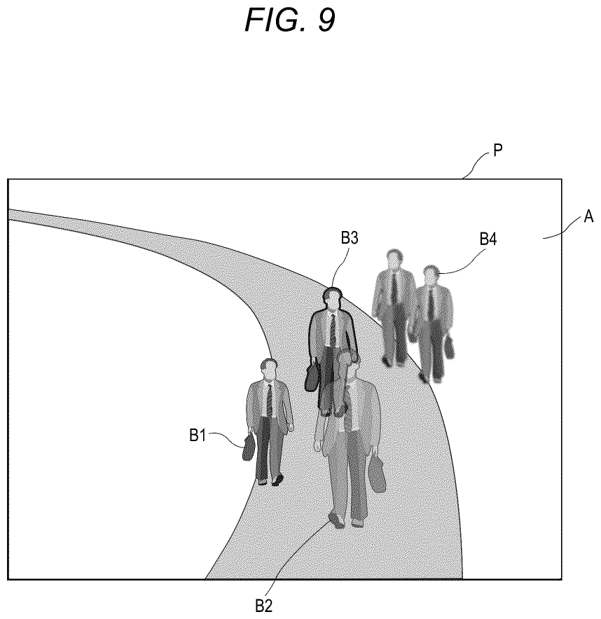

FIG. 9 illustrates an example of a screen displayed on a vehicle display device of Embodiment 3. As illustrated in FIG. 9, the individual traffic participants M₁ to M₃ are drawn as traffic participant images B1 to B3, respectively, while the integrated traffic participant M₄₋₅ is drawn as the traffic participant image B4. The display control unit 56 increases the level of drawing detail of the approaching traffic participant M₃, and draws the image B3 at a higher resolution in the display device to ensure a clearer outline and details thereof. The display control unit 56 can also attach a directional arrow on the image B3 of the approaching traffic participant M₃ to indicate a moving direction thereof (approaching the vehicle 10), or identify the image B3 by a specific color or frame, so that the driver can quickly pay attention.

For the non-approaching traffic participant M₂ located between the vehicle 10 and the approaching traffic participant M₃, the display control unit 56 performs processing in a perspective display manner to increase the transparency of the image B2 of the non-approaching traffic participant M₂, so that the image B2 does not cover the approaching traffic participant in the display screen. In addition, the display control unit 56 can further reduce details of the image B2 of the non-approaching traffic participant M₂ and simplify the display.

In the present embodiment, the display control unit 56 updates the motion trend detection and drawing of the approaching traffic participant in real time, periodically calculates the distance and motion trend between the traffic participant M and the vehicle 10, and readjusts a drawing logic once the state of the approaching traffic participant changes. For example, the traffic participant such as M₃ changes from “approaching” to “departing”, and the display control unit 56 re-evaluates the integration relationship and updates the image of the traffic participant.

In this way, the display control unit 56 dynamically adjusts the drawing manner of the traffic participant according to the motion trend thereof in real time, so that the display device can highlight a potential threat object in a more intuitive way by increasing the level of drawing detail of the approaching traffic participant, thereby helping the driver more quickly recognize and pay attention to a high-risk object. In addition, a non-approaching traffic participant located between the approaching traffic participant and the vehicle is displayed in a perspective manner to reduce an occlusion effect, so that the approaching traffic participant is displayed more clearly, thereby reducing a risk of the driver missing important information, and improving readability and safety of screen information.

### Display Control Unit: Embodiment 4

In the present embodiment, the display control unit 56 further adjusts a drawing manner of the traffic participant according to the priority of the traffic participant.

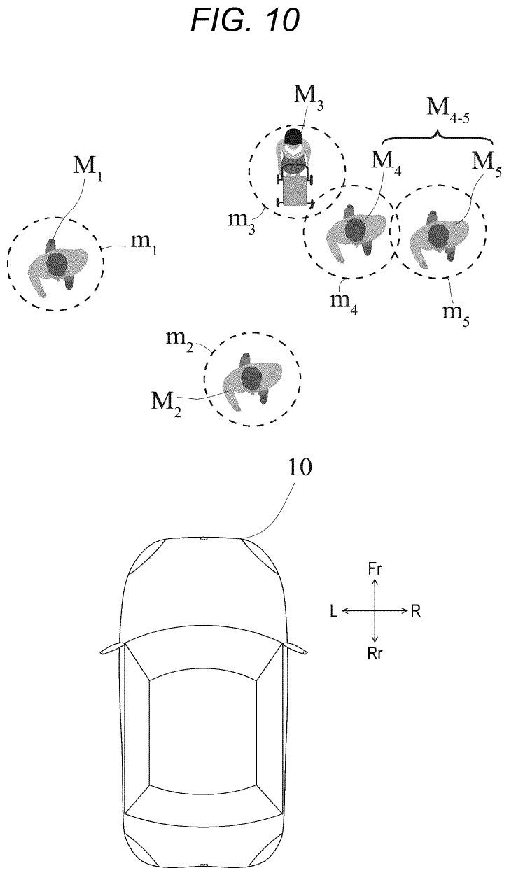

FIG. 10 illustrates an example of the traffic participant integration manner according to Embodiment 4, as illustrated in FIG. 10, the display control unit 56 determines that the traffic participants M₁, M₂ are individual traffic participants and does not integrate them, and determines that the circle m₄ of the traffic participant M₄ overlaps the circle m₃ of the traffic participant M₃ and the circle m₅ of the traffic participant M₅, and integrates the traffic participants M₃ to M₅ into one integrated traffic participant M₃₋₅. An overlap determination manner is the same as that in Embodiment 1, and will not be repeated here.

The display control unit 56 further detects whether a traffic participant requiring special attention (hereinafter, referred to as a “traffic participant requiring attention”) is present, and if the traffic participant is present and is included in the integrated traffic participant, the display control unit 56 separates the traffic participant requiring attention from the integrated traffic participant.

Specifically, the display control unit 56 filters the priorities of the traffic participants according to the field content of the traffic participant information table, and selects a traffic participant whose priority is “high” and marks the traffic participant as the traffic participant requiring attention. A traffic participant with a higher priority generally poses a greater potential risk or presents a higher driving interference, and examples thereof include vulnerable traffic participants such as pedestrians pushing strollers, children riding bicycles, and teenagers playing on skateboards.

As an example, in the present embodiment, the priority of the traffic participant M₃ is “high”, so that the traffic participant M₃ is recognized as the traffic participant requiring attention. Since the traffic participant requiring attention M₃ is included in the integrated traffic participant M₃₋₅, the display control unit 56 separates M₃ from the integrated traffic participant as an individual traffic participant. The separated integrated traffic participant M₃₋₅ will only include M₄, M₅, and M₄, M₅ are reintegrated into the integrated traffic participant M₄₋₅.

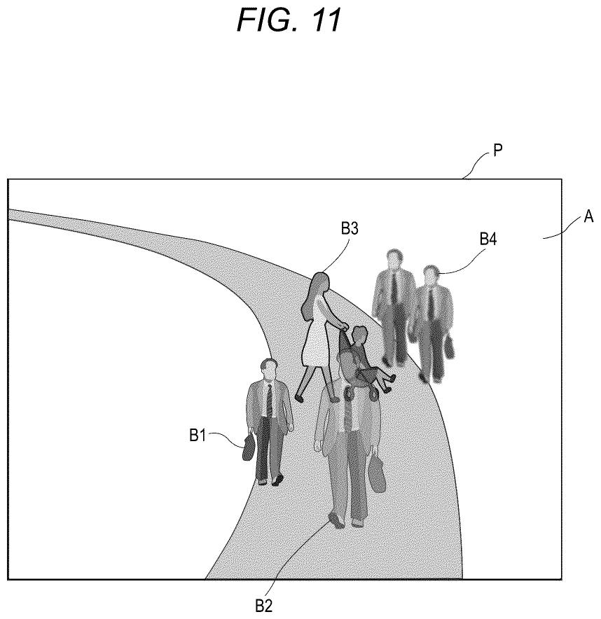

FIG. 11 illustrates an example of a screen displayed on the vehicle display device of Embodiment 4. As illustrated in FIG. 11, for the traffic participant requiring attention M₃, the display control unit 56 separately draws him or her as the image B3, increases the level of drawing detail thereof, and draws the image B3 at a higher resolution to ensure a clearer outline and details thereof. The display control unit 56 can also identify the image B3 of the traffic participant M₃ by a specific color, border, flashing effect, or the like, for the driver to quickly pay attention.

For the traffic participant M₂ located between the vehicle 10 and the traffic participant requiring attention M₃, the display control unit 56 performs processing in a perspective display manner to increase the transparency of the image B2 of the traffic participant M₂, so that the image B2 does not cover the traffic participant requiring attention M₃ in the display screen. In addition, the display control unit 56 can further reduce details of the image B2 of the non-approaching traffic participant M₂ and simplify the display.

In this way, the display control unit 56 determines the traffic participant requiring attention and separates him or her from the integrated object for independent display, and increases a highlighting effect, which can provide the driver with a highlighted information prompt of a key traffic participant and optimize a prompt effect of the driving assistance system, thereby helping the driver more quickly recognize and pay attention to a high-risk object. In addition, other traffic participants located between the traffic participant requiring attention and the vehicle are displayed in the perspective manner to reduce an occlusion effect, so that the traffic participant requiring attention is displayed more clearly, and a risk of the driver missing an important object is reduced.

### Display Control Unit: Embodiment 5

In Embodiment 1, if the plurality of traffic participants M belong to the same attribute and are close to each other, the display control unit 56 integrates these traffic participants into one integrated traffic participant for display.

In Embodiment 5, the display control unit 56 further integrates the traffic participants based on the distance of the traffic participants relative to the vehicle 10. Specifically, when the plurality of traffic participants M with the same attribute are located in a specific line-of-sight range of the vehicle 10, and distances between these traffic participants M and the vehicle 10 all fall in a specified range, these traffic participants are integrated according to a specific rule.

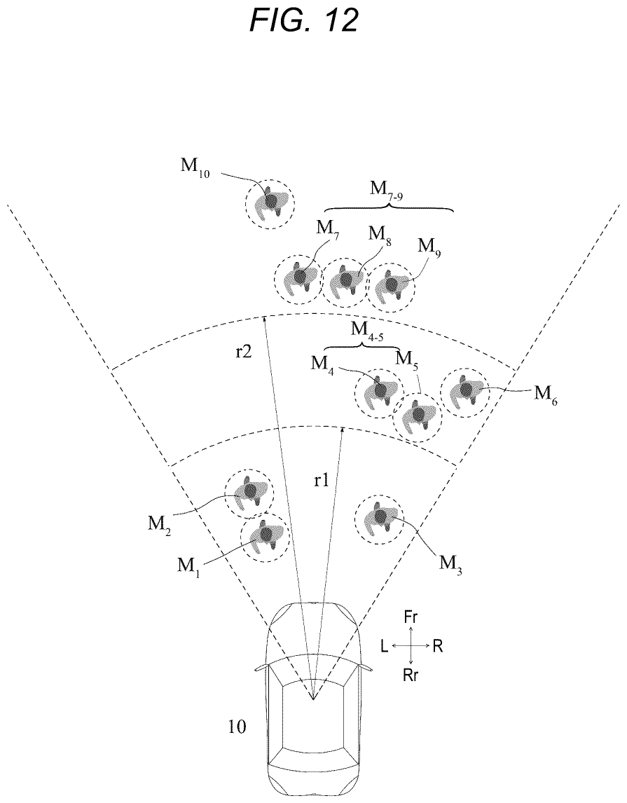

FIG. 12 illustrates a traffic participant integration logic in Embodiment 5. The display control unit 56 first establishes a coordinate system on a top view plane of the vehicle 10, and projects position information of each traffic participant M into the coordinate system. Then, a traffic participant within a line-of-sight range of a specified angle (for example, an angle of)+30° is selected by taking a center of the vehicle 10 as a start point and a line-of-sight straight-front direction of the vehicle 10 as 0 degrees. Meanwhile, a distance range (for example, a short distance, a medium distance, and a long distance) is divided based on a specified first radius r1 and a specified second radius r2 by taking the center of the vehicle 10 as a circle center. For the selected traffic participants, the display control unit 56 performs different degrees of integration processing according to different distance ranges: the traffic participants in the short-distance range remain in a separate state and are not integrated; at most every two of the traffic participants in the medium-distance range are integrated as one integrated traffic participant; and at most every four of the traffic participants in the long-distance range are integrated as one integrated traffic participant.

It should be noted that the number of integrations (such as two and four) is only an example and does not constitute a limitation to the present invention.

In addition, in the present embodiment, the ranges of the short distance, the medium distance, and the long distance can be dynamically adjusted as the vehicle 10 travels. For example, when the travel speed of the vehicle 10 is high, in order to reduce a visual burden on the driver, the distance range can be expanded, so that traffic participants in a longer distance are displayed in an integrated form, thereby focusing the attention of the driver on more important areas.

When the vehicle 10 decelerates or travels at a low speed, the distance range can be reduced to allow more traffic participants to be displayed separately, so that the driver can clearly understand the details of the surrounding environment, and more accurate environmental information is provided especially in complex scenarios (such as parking lots or congested roads).

The dynamic adjustment logic is as follows.

Initial range setting: when the vehicle is stationary or travels at a low speed, the short-distance range (first radius r1) is set to a small value, for example, 20 meters, the medium-distance range (second radius r2) is set to 50 meters, and the long-distance range is a part exceeding 50 meters.

Dynamic range adjustment: the higher the travel speed of the vehicle 10, the larger r1 and r2. For example, when the travel speed reaches 60 km/h, the short-distance range can be expanded to 50 meters, the medium-distance range can be expanded to 100 meters, and the long-distance range can be beyond 100 meters.

Real-time update range: the display control unit 56 updates the range of r1 and r2 in real time according to the speed sensor data or other vehicle speed information of the vehicle 10, and dynamically adjusts the grouping and integration logic of the traffic participants.

For example, as illustrated in FIG. 12, the traffic participants M₁ to M₉ within a line-of-sight range of ±30 degrees are integrated as follows.

Since the traffic participants M₁ to M₃ are located in the range of the first radius r1 (short-distance range), they remain as individual traffic participants, and even if traffic participants M₁ and M₂ have an overlapping positional relationship, they are not integrated.

The traffic participants M₄ to M₆ are located in the medium-distance range between the first radius r1 and the second radius r2, and they have an overlapping position relationship, and at most every two of the traffic participants in the medium-distance range are required to be integrated as one integrated traffic participant, so that the traffic participants M₄ and M₅ are integrated into one integrated traffic participant M₄₋₅, and the traffic participant M₆ remains as an individual traffic participant.

Traffic participants M₇ to M₁₀ are located in the long-distance range outside the second radius r2, where M₇, M₈ and M₉ have an overlapping positional relationship, and therefore are integrated into one integrated traffic participant M₇-9, while the traffic participant M₁₀ does not overlap other traffic participants and remains as an individual traffic participant.

An overlap determination manner is the same as that in Embodiment 1, and the description thereof is omitted.

Then, the display control unit 56 separately renders the individual traffic participants and the integrated traffic participant, and superimposes them on the external environment recognition image A according to the information on the traffic participants. The individual traffic participants M₁, M₂, M₃, M₆, M₁₀ are drawn as individual traffic participant images, respectively, the integrated traffic participants M₄₋₅, M₇₋₉ are drawn as the integrated traffic participant images, respectively, and the specific drawing manner is the same as that of Embodiment 1 to 4, which will not be repeated here.

In Embodiment 5, the display control unit 56 can flexibly adjust an integrated display strategy according to the distance between the vehicle and the traffic participant, thereby further optimizing the display manner. The display control unit 56 can also dynamically adjust the ranges of the short distance, the medium distance and the long distance in combination with the travel speed of the vehicle 10, reduce the visual interference of the driver when driving at a high speed, and provide more accurate environmental information when driving at a low speed, thereby further helping the driver quickly and accurately recognize surrounding traffic participants, reducing the redundancy of visual information, and prolonging the range of the electric vehicle.

In the foregoing embodiment, an example in which the mobile device is used as a vehicle (a four-wheeled vehicle) is described, but is not limited thereto. For example, the vehicle may alternatively be a two-wheeled vehicle, a Segway, or the like. In addition, the concept of the present disclosure is not limited to vehicles, and can also be applied to robots, ships, aircraft, and the like equipped with a drive source and movable by the power of the drive source.

The present invention is not limited to the above-described embodiments, and modifications, improvements, or the like can be made as appropriate. For example, an integration condition (changing the minimum and/or maximum number of traffic participants constituting the integrated traffic participant) can also be dynamically adjusted according to attributes of the traffic participants to adapt to display requirements of different types of traffic participants. For example, a greater number of integrations may be allowed for the pedestrian group, while a smaller number of integrations is maintained for the vehicles, thereby enhancing flexibility and practical applicability of the display effect.

In addition, it is possible to prioritize traffic participants in the moving direction of the vehicle by combining the traveling direction and a target path of the vehicle, and reduce interference caused by traffic participants in irrelevant areas to the system.

In addition, a control method described in the above-described embodiments can be implemented by executing a pre-prepared control program. The control program is recorded in a computer-readable storage medium and executed by reading from the storage medium. In addition, the control program can be provided in a form of a non-transitory storage medium such as a flash memory, or can be provided through a network such as the Internet. The computer that executes the control program can be provided in the control device, or in an electronic device such as a smartphone, a tablet terminal, or a personal computer that can communicate with the control device, or in a server device that can communicate with the control device and the electronic device.

In addition, the present invention includes at least the following items, corresponding components or the like in the above-described embodiments are indicated in brackets, but the present invention is not limited thereto.

### Scheme 1

A mobile device (the vehicle 10) including:
an external information acquisition device (the cameras 12 and the external environment recognition unit 55) configured to acquire external information around the mobile device;
an acquisition device (the traffic participant detection unit 57) configured to acquire traffic participant information from the external information; and
a display device (the display control unit 56 and the touchscreen 42) configured to generate and display an image representing a traffic condition around the mobile device based on the external information and the traffic participant information, in which
the traffic participant information includes attribute information of each traffic participant, and
when generating the image, the display device integrates a plurality of the traffic participants belonging to a same attribute and having a specific position relationship into an integrated traffic participant, and draws the integrated traffic participant as a single object.

According to the mobile device of scheme 1, when it is detected that the plurality of traffic participants are present in front, the traffic participants with a specific position relationship are recognized as a group, and visually presented on a display screen in a simplified and integrated group form, thereby reducing unnecessary complex information drawing, simplifying visual information on the display screen, helping a driver quickly understand important information related to the vehicle, effectively reducing a processing load and power consumption of a display system, and prolonging a range of an electric vehicle.

### Scheme 2

The mobile device according to scheme 1, in which
the attribute includes a person, a vehicle, and an animal.

In the mobile device of scheme 2, by classifying attributes (such as a person, a vehicle, and an animal) of the traffic participants, the system may more accurately recognize and distinguish categories of the traffic participants, improve accuracy of the integrated traffic participant and universality of an application scenario, and help provide specific display optimization for participants of different categories.

### Scheme 3

The mobile device according to scheme 1 or 2, in which
when a plurality of the integrated traffic participants are present in the generated image, the display device changes a level of drawing detail of each of the integrated traffic participants according to a distance between the integrated traffic participant and the mobile device, and
the level of drawing detail of the integrated traffic participant close to the mobile device is higher than the level of drawing detail of the integrated traffic participant far from the mobile device.

In the mobile device of scheme 3, by dynamically adjusting the level of drawing detail based on the distance between the integrated traffic participant and the mobile device, the traffic participant close to the mobile device is displayed in more detail, and therefore an identification capability for potential hazards is improved; the traffic participant far away from the mobile device is displayed in a simplified manner, and therefore screen overload is avoided, and display efficiency and visual concentration are improved.

### Scheme 4

The mobile device according to any one of schemes 1 to 3, in which the display device changes a minimum number and/or a maximum number of traffic participants constituting the integrated traffic participant according to the attribute.

The mobile device of scheme 4 may adapt to the display requirements of different types of traffic participants by dynamically adjusting the integration condition (such as the minimum or maximum number) according to the attributes of the traffic participants. For example, a greater number of integrations may be allowed for the pedestrian group, while a smaller number of integrations is maintained for the vehicles, thereby enhancing flexibility and practical applicability of the display effect.

### Scheme 5

The mobile device according to any one of schemes 1 to 4, in which
the display device divides a periphery of the mobile device into a plurality of areas based on a distance from the mobile device, and takes a plurality of traffic participants located in a same area as the plurality of traffic participants having the specific position relationship.

By dividing the areas (such as short distance, medium distance, and long distance) based on distances and integrating the traffic participants in each area, the mobile device of scheme 5 may better optimize the integration logic, improve the hierarchy of the display screen and the accuracy of information expression, and is particularly suitable for a complex traffic environment.

### Scheme 6

The mobile device according to scheme 5, in which
the display device changes a minimum number and/or a maximum number of the traffic participants constituting the integrated traffic participant according to a distance between the area and the mobile device.

The mobile device of scheme 6, combined with area division, may flexibly adjust the integrated display strategy (such as the minimum or maximum number of integration) according to the distance between the vehicle and traffic participant, thereby achieving finer-grained display optimization and further optimizing the display manner.

### Scheme 7

The mobile device according to any one of schemes 1 to 6, in which
the acquisition device detects a traffic participant moving toward the mobile device as an approaching traffic participant, and
the display device separates the approaching traffic participant from the integrated traffic participant and draws the approaching traffic participant as an individual object when the approaching traffic participant is included in the plurality of traffic participants as the integrated traffic participant.

In the mobile device of scheme 7, by detecting the approaching traffic participant approaching the mobile device and separating him or her from the integrated object for independent display, the traffic participant who is a potentially hazard may be highlighted, the alertness and response speed of the driver may be improved, and driving safety may be enhanced.

### Scheme 8

The mobile device according to scheme 7, in which
the display device renders the approaching traffic participant with a higher level of drawing detail than a non-approaching traffic participant.

The mobile device of scheme 8 increases the level of drawing detail of the approaching traffic participant to enable the display device to highlight a potential threat object in a more intuitive way, thereby helping the driver to more quickly recognize and pay attention to a high-risk object.

### Scheme 9

The mobile device according to scheme 7 or 8, in which
the display device displays a non-approaching traffic participant with transparency, the non-approaching traffic participants being located between the mobile device and the approaching traffic participant and covering at least a part of the approaching traffic participant in the generated image.

According to the mobile device in scheme 9, the non-approaching traffic participant located between the approaching traffic participant and the vehicle is displayed in a perspective manner to reduce an occlusion effect, so that the approaching traffic participant is displayed more clearly, thereby reducing a risk of the driver missing important information and improving readability and safety of screen information.

### Scheme 10

The mobile device according to any one of schemes 1 to 6, in which
the acquisition device determines whether each traffic participant requires attention, and
the display device separates a traffic participant requiring attention from the integrated traffic participant and draws the traffic participant requiring attention as an individual object when the traffic participant requiring attention is included in the plurality of traffic participants as the integrated traffic participant.

In the mobile device of scheme 10, by determining the traffic participant requiring attention (for example, a pedestrian pushing a stroller) and separating him or her from an integrated object for independent display, a highlighted information prompt of a key traffic participant may be provided for the driver, a prompt effect of the driving assistance system may be optimized, and intelligence and relevance of the system may be enhanced.

### Scheme 11

The mobile device according to scheme 10, in which
the display device highlights the traffic participant requiring attention.

In the mobile device of scheme 11, the potential risk may be more intuitively prompted to the driver by highlighting the traffic participant requiring attention, for example, using a color, a frame, or a dynamic effect, thereby significantly improving attention distribution efficiency and response capability of the driver.

### Scheme 12

The mobile device according to scheme 10 or 11, in which
the display device displays a traffic participant not requiring attention with transparency, the traffic participant not requiring attention being located between the mobile device and the traffic participant requiring attention and covering at least a part of the traffic participant requiring attention in the generated image.

In the mobile device of scheme 12, by displaying the traffic participant not requiring attention with transparency, the occlusion of the traffic participant requiring attention is avoided, thereby ensuring clear presentation of key traffic information, reducing the risk of false determination caused by visual interference, and improving hierarchy and accuracy of information expression.

### Scheme 13

A method for generating and displaying an image representing a traffic condition around a mobile device, the method including steps of:
executed by a computer installed in the mobile device,
acquiring traffic participant information from external information around the mobile device acquired by an external information acquisition device of the mobile device; and
generating and displaying the image representing the traffic condition around the mobile device based on the external information and the traffic participant information, in which
when the image is generated, a plurality of traffic participants belonging to a same attribute and having a specific position relationship are integrated into one integrated traffic participant, and the integrated traffic participant is drawn as one single object.

### Scheme 14

A non-transitory computer-readable storage medium storing a computer program including instructions which cause a computer to execute the method according to scheme 13.

Schemes 13 and 14 further provide the control method and the non-transitory computer-readable storage medium storing the computer program that enable the computer installed in the mobile device to visually present the traffic participants in a simplified and integrated group form, reduce unnecessary complex information drawing, simplify visual information on a display screen, help a driver quickly understand important information related to a vehicle, effectively reduce a processing load and power consumption of a display system, and prolong a range of an electric vehicle.

### REFERENCE SIGNS LIST

10 vehicle
11L left side mirror
11R right side mirror
14 operation input unit
16 sensor group
12 camera
12Fr front-view camera
12Rr rear-view camera
12L left side camera
12R right side camera
32 sonar group
32a front sonar group
32b rear sonar group
32c left side sonar group
32d right side sonar group
34a, 34b wheel sensor
36 vehicle speed sensor
38 operation detection unit
18 navigation device
42 touchscreen44 speaker
20 control ECU
50 input and output unit
52 calculation unit
55 external environment recognition unit
56 display control unit
57 traffic participant detection unit
54 storage unit
22 EPS system
100 rudder angle sensor
102 torque sensor
104 EPS motor
106 rotary encoder
108 EPS ECU
110 steering device
112 steering column
24 communication unit
26 driving force control system
130 drive ECU
28 braking force control system
132 brake ECU
120 communication device
M traffic participant

What is claimed is:

1. A mobile device comprising:
an external information acquisition device configured to acquire external information around the mobile device;
an acquisition device configured to acquire traffic participant information from the external information; and
a display device configured to generate and display an image representing a traffic condition around the mobile device based on the external information and the traffic participant information, wherein
the traffic participant information includes attribute information of each traffic participant, and
when generating the image, the display device integrates a plurality of the traffic participants belonging to a same attribute and having a specific position relationship into an integrated traffic participant, and draws the integrated traffic participant as a single object.

2. The mobile device according to claim 1, wherein
the attribute includes a person, a vehicle, and an animal.

3. The mobile device according to claim 1, wherein
when a plurality of the integrated traffic participants are present in the generated image, the display device changes a level of drawing detail of each of the integrated traffic participants according to a distance between the integrated traffic participant and the mobile device, and
the level of drawing detail of the integrated traffic participant close to the mobile device is higher than the level of drawing detail of the integrated traffic participant far from the mobile device.

4. The mobile device according to claim 1, wherein
the display device changes a minimum number and/or a maximum number of traffic participants constituting the integrated traffic participant according to the attribute.

5. The mobile device according to claim 1, wherein
the display device divides a periphery of the mobile device into a plurality of areas based on a distance from the mobile device, and takes a plurality of traffic participants located in a same area as the plurality of traffic participants having the specific position relationship.

6. The mobile device according to claim 5, wherein
the display device changes a minimum number and/or a maximum number of the traffic participants constituting the integrated traffic participant according to a distance between the area and the mobile device.

7. The mobile device according to claim 1, wherein
the acquisition device detects a traffic participant moving toward the mobile device as an approaching traffic participant, and
the display device separates the approaching traffic participant from the integrated traffic participant and draws the approaching traffic participant as an individual object when the approaching traffic participant is included in the plurality of traffic participants as the integrated traffic participant.

8. The mobile device according to claim 7, wherein
the display device renders the approaching traffic participant with a higher level of drawing detail than a non-approaching traffic participant.

9. The mobile device according to claim 7, wherein
the display device displays a non-approaching traffic participant with transparency, the non-approaching traffic participant being located between the mobile device and the approaching traffic participant and covering at least a part of the approaching traffic participant in the generated image.

10. The mobile device according to claim 1, wherein
the acquisition device determines whether each traffic participant requires attention, and
the display device separates a traffic participant requiring attention from the integrated traffic participant and draws the traffic participant requiring attention as an individual object when the traffic participant requiring attention is included in the plurality of traffic participants as the integrated traffic participant.

11. The mobile device according to claim 10, wherein
the display device highlights the traffic participant requiring attention.

12. The mobile device according to claim 10, wherein
the display device displays a traffic participant not requiring attention with transparency, the traffic participant not requiring attention being located between the mobile device and the traffic participant requiring attention and covering at least a part of the traffic participant requiring attention in the generated image.

13. A method for generating and displaying an image representing a traffic condition around a mobile device, the method comprising:
executed by a computer installed in the mobile device;
acquiring traffic participant information from external information around the mobile device acquired by an external information acquisition device of the mobile device; and
generating and displaying the image representing the traffic condition around the mobile device based on the external information and the traffic participant information, wherein
when the image is generated, a plurality of traffic participants belonging to a same attribute and having a specific position relationship are integrated into one integrated traffic participant, and the integrated traffic participant is drawn as one single object.

14. A non-transitory computer-readable storage medium storing a computer program comprising instructions which cause a computer to execute the method according to claim 13.
